(19) United States
(12) Patent Application Publication
(10) Pub. No.: US 2001/0015975 A1
(43) Pub. Date: Aug. 23, 2001

(54) Packet monitoring system

(76) Inventor: Tsuneyuki Kikuchi, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/788,566

(22) Filed: Feb. 21, 2001

(30) Foreign Application Priority Data
Feb. 22, 2000 (JP) 50476/2000

(51) Int. Cl. H04L 12/28

(52) U.S. Cl. 370/389; 370/498

(57) ABSTRACT

A system for monitoring packets transmitted on a channel (3) connecting an application server (8) and a user (1) of the application server (8) to each other, includes (a) a certification server (5) which certificates a user, and (b) a first device (6) which, on receipt of a request from the certification server (5), monitors packets transmitted on the channel (3). The certification server (5) includes a first memory (9) which stores a monitoring parameter designating a packet to be monitored, and a threshold parameter designating a method of monitoring the packet, and a second device (11) which transmits a request to the first device (6) to start or finish monitoring the packet. The first device includes an analyzer (16) which monitors a time at which packets coincident with the monitoring parameter arrive, and determines whether there is any rule in an interval in the arrival time, and an annunciator (17) which makes annunciation to the user when there is a certain rule in the interval. (Drawing to be published: FIG. 1)

### BACKGROUND OF THE INVENTION

1. Field of the Invention

The invention relates to a system for monitoring a packet which system is capable of avoiding improperly counting service fee or communication fee due to mechanical count of data made in accordance with a measured rate fee system.

2. Description of the Related Art

A service fee to be paid for using an electronic mail and web includes a fee for connecting a service provider and a fee to be paid to a communication company. A fee determined in accordance with a current fee system in both a service provider and a communication company includes a basic fee and an additional fee based on a communication time and a communication distance. However, some service providers and communication companies select a measured rate fee system in which a service fee is determined in accordance with an amount of transmitted or received data. A measured rate fee system is expected to be more widely used in the future.

With the diffusion of Internet technology, we can select various services on Internet. For instance, a user can download a requisite communication software from an application server (hereinafter, referred to simply as “AP server”), and receive services accordingly. Some of services use a communication protocol inherent thereto, and transmit and receive control information between communication softwares without letting a user know such control information. For instance, one of such services is confirmation service carried out by a chat server, in which a terminal is periodically checked as to whether it starts up.

The above-mentioned measured rate fee system is accompanied with a problem that since a service fee is determined in accordance with an amount of data transmitted through a channel, a user may have to pay to control information although the user did not know the control information. This is caused by mechanical count of data. Such mechanical count of data would increase inconsistency between a fee which a user has to actually pay and a fee which a user is requested to pay, resulting in deterioration in credibility of a service provider to a user.

Japanese Unexamined Patent Publication No. 10-247911 has suggested an apparatus of managing events occurring in a system including a plurality of servers, comprising a memory used by all of the servers, a detector equipped with each of the servers for detecting an event occurring in each of the servers, and transmitting information about the event through a network, and a manager equipped with any one of the servers for receiving the event information and storing the thus received event information into the memory.

Japanese Unexamined Patent Publication No. 11-220513 has suggested a data-providing system including a server and a plurality of terminals. When one of the terminals transmits a request to the server, the server transmits service contents to the terminal through a plurality of communication networks.

However, the above-mentioned problem remains unsolved even in the apparatus and the system suggested in the above-identified Publications.

### SUMMARY OF THE INVENTION

In view of the above-mentioned problem in the prior art, it is an object of the present invention to provide a system of monitoring a packet which system is capable of preventing that a user has to pay to control information although the user did not know the control information, and of determining a proper fee in accordance with service a user received.

It is also an object of the present invention to provide a method of monitoring a packet which method is capable of doing the same.

In one aspect of the present invention, there is provided a system for monitoring packets transmitted on a channel connecting an application server and a user of the application server to each other including (a) a certification server which certificates a user, and (b) a first device which, on receipt of a request from the certification server, monitors packets transmitted on the channel.

For instance, the certification server may be designed to include (a1) a first memory which stores a user management table including ID numbers of users, passwords by which users are identified, a monitoring parameter designating a packet to be monitored, and a threshold parameter designating a method of monitoring the packet, and (a2) a second device which transmits a request to the first device to start or finish monitoring the packet at a timing when the user logs-in or logs-out his/her terminal.

For instance, the first device may be designed to include (b1) a second memory which stores a first time at which a packet transmitted from one of the application server and the user arrives, when the first device receives a request from the second device to monitor the packet, (b2) an analyzer which monitors a second time at which packets coincident with the monitoring parameter arrive, based on the first time, when the first device receives a request from the second device to monitor the packet, and determines whether there is any rule in an interval in the second time, and (b3) an annunciator which makes annunciation to the user when there is a certain rule in the interval.

The certification server may be designed to further include a third device which updates the monitoring parameter and the threshold parameter, when instructed by the user.

The first device may be designed to further include (b1) a third memory which stores the monitoring parameter transmitted from the second device, (b2) a fourth memory which stores the threshold parameter transmitted from the second device, and (b3) a fourth device which the third and fourth memories when the second device transmits a request to the first device to start or finish monitoring the packet.

It is preferable that the analyzer analyzes whether there is any rule in the interval and whether the interval exceeds the threshold parameter, and the annunciator makes annunciation to the user when the analyzer judges that there is a certain rule in the interval and that the interval exceeds the threshold parameter.

In another aspect of the present invention, there is provided a method of monitoring packets transmitted on a channel connecting an application server and a user of the application server to each other, including the steps of (a) acquiring a monitoring parameter indicative of a packet to be monitored, when the user logs-in his/her terminal, (b) monitoring a time at which packets coincident with the monitoring parameter arrive, and determining whether there is any rule in an interval in the arrival time, and (c) making annunciation to the user when there is a certain rule in the interval.

The method may further include the step of ceasing the step (b) when the user logs-out his/her terminal.

For instance, the monitoring parameter is included in a user management table which further includes an ID number of the user, a password by which the user is identified, and a threshold parameter designating a method of monitoring the packet, in which case, the step (a) may be designed to include the steps of (a1) retrieving the user management table, based on the ID number and the password both input by the user, (a2) acquiring the monitoring parameter, if the monitoring parameter is stored in the user management table, and (a3) acquiring the threshold parameter, if the threshold parameter is stored in the user management table.

For instance, the step (b) may be designed to include the step of analyzing whether there is a certain rule in the interval and whether the interval exceeds the threshold parameter, after acquiring the threshold parameter in the step (a2), and the step (c) includes the step of making annunciation to the user, if there is a certain rule in the interval and the interval exceeds the threshold parameter.

In still another aspect of the present invention, there is provided a recording medium readable by a computer, storing a program therein for causing a computer to act as the above-mentioned system of monitoring packets transmitted on a channel connecting an application server and a user of the application server to each other.

There is further provided a recording medium readable by a computer, storing a program therein for causing a computer to carry out the above-mentioned method of monitoring packets transmitted on a channel connecting an application server and a user of the application server to each other.

The advantages obtained by the aforementioned present invention will be described hereinbelow.

In accordance with the present invention, it would be possible to prevent a user from paying an improper service fee or communication fee which is caused due to mechanical count of data in a measured rate fee system.

In addition, the present invention makes it possible to set parameters taking into consideration services which a user predominantly utilizes, and identify a packet which is to be annunciated to a user. Hence, it would be possible to enhance an efficiency in determining whether there is any rule in an interval in times at which packets to be monitored arrive.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a packet monitoring system in accordance with a preferred embodiment of the present invention.

FIG. 2 illustrates an example of a monitoring parameter.

FIG. 3 illustrates an example of a threshold parameter.

FIG. 4 illustrates an example of a user management table.

FIG. 5 is a flow-chart of an operation of the packet monitoring system in accordance with the embodiment.

FIG. 6 is a flow-chart of an operation of the packet monitoring system in accordance with the embodiment.

FIG. 7 illustrates examples of recording mediums in which a program for controlling a packet monitoring system is to be stored.

### DESCRIPTION OF THE PREFERRED EMBODIMENT

A preferred embodiment in accordance with the present invention will be explained hereinbelow with reference to drawings.

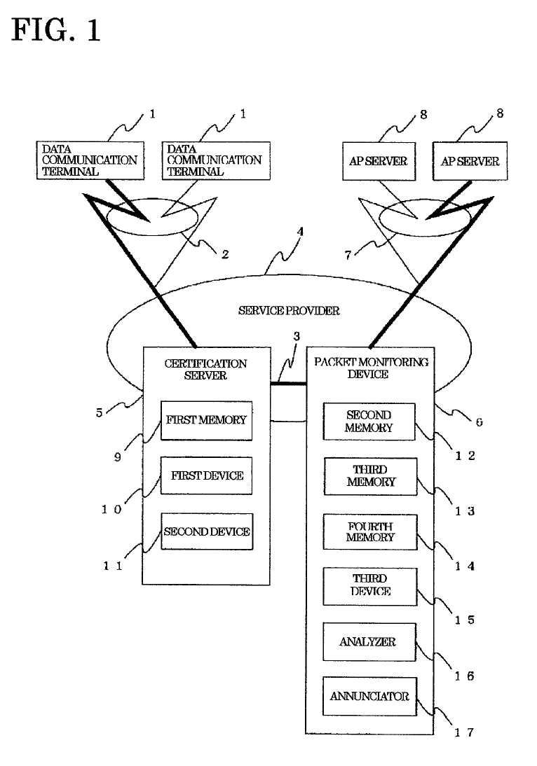

FIG. 1 is a block diagram of a packet monitoring system in accordance with an embodiment of the present invention.

In FIG. 1, a user makes a contract with a service provider 4 with respect to a service fee, packet monitoring, and so on. A user receives services and content information in his/her data communication terminal 1 from an application server (AP server) 8 through a wire/wireless network 2, a channel 3, the service provider 4 and Internet 7. Herein, a packet means a block comprised of user data and a header. Data is transmitted in such blocks in an Internet transfer protocol. The header means control data including, for instance, addresses of a transmitter and a receiver, a service identifier, a check sum, and sizes of user data and a header.

The service provider 4 includes a certification server 5 which certificates a user, and a packet monitoring device 6 which monitors packets transmitted and received through the channel 3. In the specification, the term “service provider” includes a communication company which provides a wire and/or wireless channel.

The certification server 5 is comprised of a first memory 9 storing a user management table therein, a first device 10 which updates storage of the first memory 9 on receipt of an instruction from a user, and a second device 11 which makes a request to the packet monitoring device 6 to start or finish packet monitoring at a timing when a user logs-in or logs-out the certification server 5.

The first device 10 updates storage of the first memory 9, based on a monitoring parameter and a threshold parameter presented by the service provider 4 when a contract between a user and the service provider 4 was made.

As an alternative, the first device 10 updates storage of the first memory 9, based on a monitoring parameter and a threshold parameter provided by a user on a world-wide-web (WWW) homepage presented by the service provider 4.

As an alternative, the first device 10 updates storage of the first memory 9, based on a monitoring parameter and a threshold parameter provided by a user on a program used for setting parameters which program is presented by the service provider 4 and is operable on the data communication terminal 1 of a user.

The parameter monitoring device 6 is comprised of a second memory 12 which stores a monitoring parameter therein, a third memory 13 storing a threshold parameter therein, a fourth memory 14 storing a time at which each of packets having been transmitted from either the data communication terminal 1 or the AP server 8 arrives at the packet monitoring device 6, a third device 15 which updates storage of the second and third memories 12 and 13 at a timing when the packet monitoring device 6 receives a request from the certification server 5 to start or finish packet monitoring, an analyzer 16 which analyzes as to whether there is any rule in an interval between packet arrival, and an annunciator 17 which makes annunciation to a user.

Annunciation to a user is made as follows, for instance. The annunciator 17 makes annunciation to a user in the form of written documents or a notice board. As an alternative, the annunciator 17 makes annunciation to a user by attaching a notice or warning to a communication protocol used in a service provided by the service provider 4. As an alternative, the annunciator 17 makes annunciation to a user by sending a warning program operable on the data communication terminal 1, to a user.

A monitoring parameter is comprised of addresses of a transmitter and a receiver, a service identifier, data sequence having any size and starting from any position in user data, and a check sum solely or in combination. Herein, addresses of a transmitter and a receiver means control data indicative of a user who transmits a packet and a user who is to receive a packet. A service identifier means control data used for identifying a service which the AP server 8 provides to a user, such as e-mail service. A check sum means control data used for checking whether user data and a header were damaged when transferred. If user data and a header for a first check sum are coincident with user data and a header for a second check sum, the first and second check sums are equal to each other.

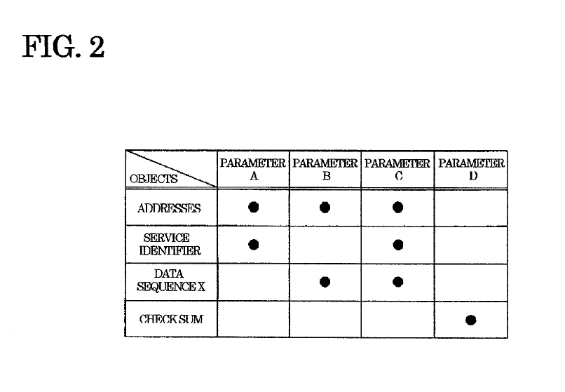

FIG. 2 illustrates examples of monitoring parameters comprised of one or more of objects to be monitored. For instance, a monitoring parameter A is comprised of addresses of a transmitter and a receiver, and a service identifier, a monitoring parameter B is comprised of addresses of a transmitter and a receiver, and data sequence having any size and starting from any position in user data (hereinafter, such data sequence is referred to simply as “data sequence X”), a monitoring parameter C is comprised of addresses of a transmitter and a receiver, a service identifier, and data sequence X, and a monitoring parameter D is comprised only of a check sum.

For instance, the monitoring parameter A may be used as a parameter for monitoring whether packets used for confirming receipt of a mail are periodically transmitted to the AP server 8 which provides an electronic mail service, from the data communication terminal 1, or monitoring whether packets used for confirming start-up of a terminal are periodically transmitted to the data communication terminal 1 from the AP server 8 which provides a chat service.

The threshold parameter is comprised of (a) duration after coincidence in the monitoring parameter, (b) the number of successive coincidence in the monitoring parameter, (c) user data or header size transmitted or received after coincidence in the monitoring parameter, (d) a service fee after coincidence in the monitoring parameter, and (e) traffic on the channel 3, alone or in combination.

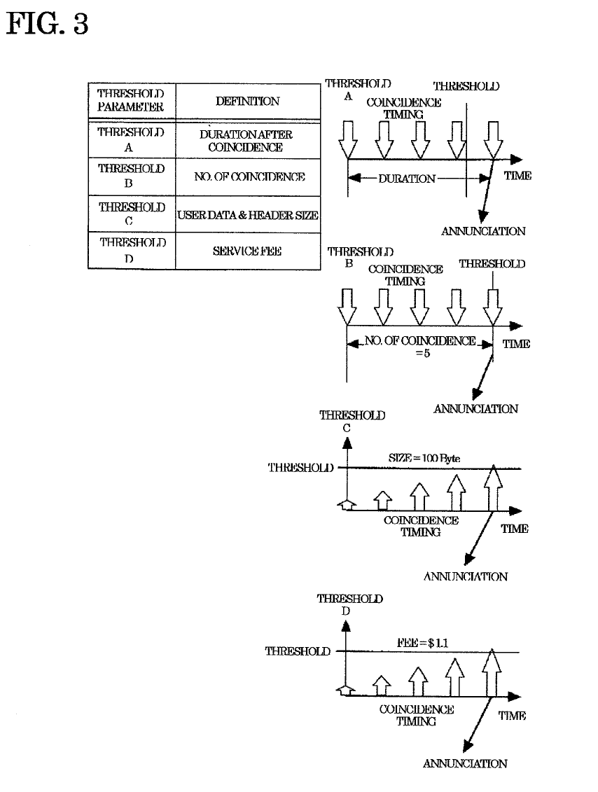

FIG. 3 illustrates an example of the threshold parameter. The threshold parameter illustrated in FIG. 3 is comprised of a threshold A comprised of duration after coincidence in the monitoring parameter, a threshold B comprised of the number of successive coincidence in the monitoring parameter, a threshold C comprised of user data or header size transmitted or received after coincidence in the monitoring parameter, or a threshold D comprised of a service fee after coincidence in the monitoring parameter.

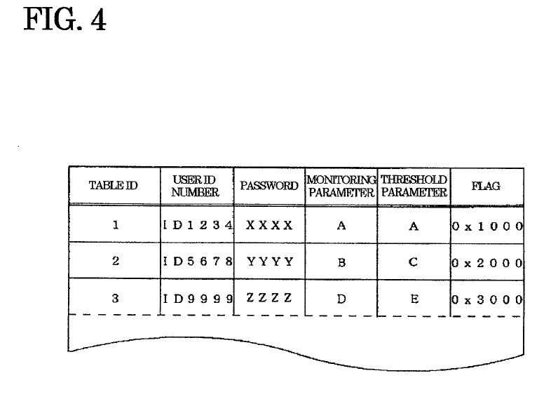

FIG. 4 illustrates an example of the user management table stored in the first memory 9.

The user management table includes ID numbers of users making a contract with the service provider 4, passwords to identify users, the above-mentioned monitoring parameter, the above-mentioned threshold parameter, and a flag indicative of whether a packet is being monitored.

Hereinbelow is explained an operation of the packet monitoring system in which a user makes a contract with the service provider 4 with respect to a service fee and packet monitoring, a user receives services and content information at his/her data communication terminal 1 from the AP server 8 through the wire/wireless communication network 2, the channel 3, the service provider 4 and the Internet 7, and the service provider 4 has the certification server 5 to certificate users and the packet monitoring device 6 to monitor packets transmitted and received through the channel 3.

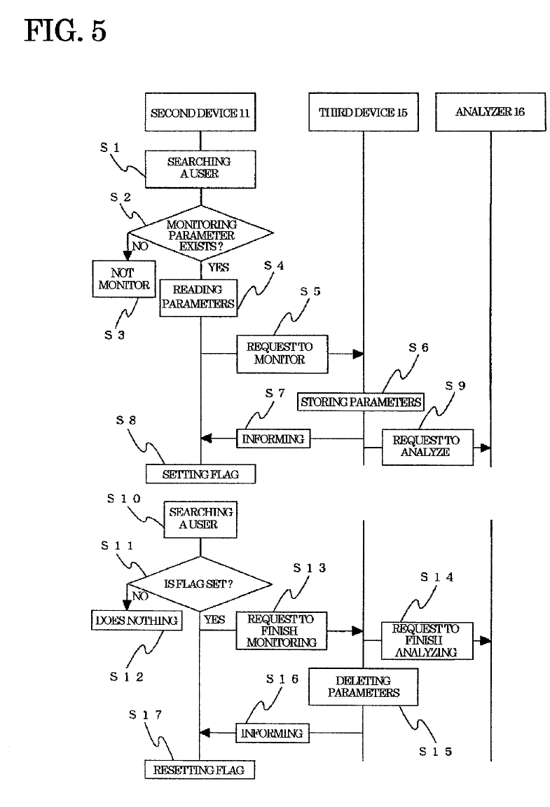

FIG. 5 is a flow-chart showing an operation of updating storage of the second and third memories 12 and 13 at a timing when a user logs-in or logs-out the certification server 5.

With reference to FIG. 5, the second device 11, when a user has logged-in the certification server 5, retrieves the first memory 9 to search the user, in step S1.

Then, the second device 11 checks whether there exists a monitoring parameter designated by the user, in step S2.

If there does not exist a monitoring parameter designated by the user (NO in step S2), a packet is not monitored in step S3.

If there exists a monitoring parameter designated by the user (YES in step S2), the second device 11 reads both a monitoring parameter and a threshold parameter out of the first memory 9, in step S4.

Then, the second device 11 makes a request to the third device 15 to start monitoring a packet, based on the thus read monitoring and threshold parameters, in step S5.

On receipt of the monitoring and threshold parameters, the third device 15 stores the monitoring parameter in the second memory 12 and the threshold parameter in the third memory 13, in step S6.

Then, the third device 15 informs the second device 11 of storage of those parameters in the second and third parameters 12 and 13, in step S7.

Being informed the storage of the parameters from the third device 15, the second device 11 sets a flag for a user who logged-in the certification server 5, in the user management memory 9, in step S8.

The third device 15 makes a request to the analyzer 16 to analyze whether there is any rule in an interval between packet arrival times indicated by the monitoring parameters, in step S9.

When a user logged-out the certification server 5, the second device 11 retrieves the user management table 9 to search a user who logged-out the certification server 5, in step S10.

Then, the second device 11 checks whether a flag associated with the user is set, in step S11.

If a flag is not set (NO in step S11), She second device 11 does nothing in step S12.

If a flag is set (YES in step S11), the second device 11 makes a request to the third device 15 to finish monitoring a packet, based on the monitoring and threshold parameters, in step S13.

On receipt of a request from the second device 11 to finish monitoring a packet, the third device 15 makes a request to the analyzer 16 to finish analysis as to whether there is any rule in an interval between packet arrival times indicated by the monitoring parameter, in step S14.

Then, the third device 15 deletes the monitoring and threshold parameters out of the second and third memories 12 and 13, in step S15.

Then, the third device 15 informs the second device 11 that the monitoring and threshold parameters were deleted, in step S16.

Being so informed, the second device 11 resets a flag for a user who logged-out the certification server 5, in the user management memory 9, in step S17.

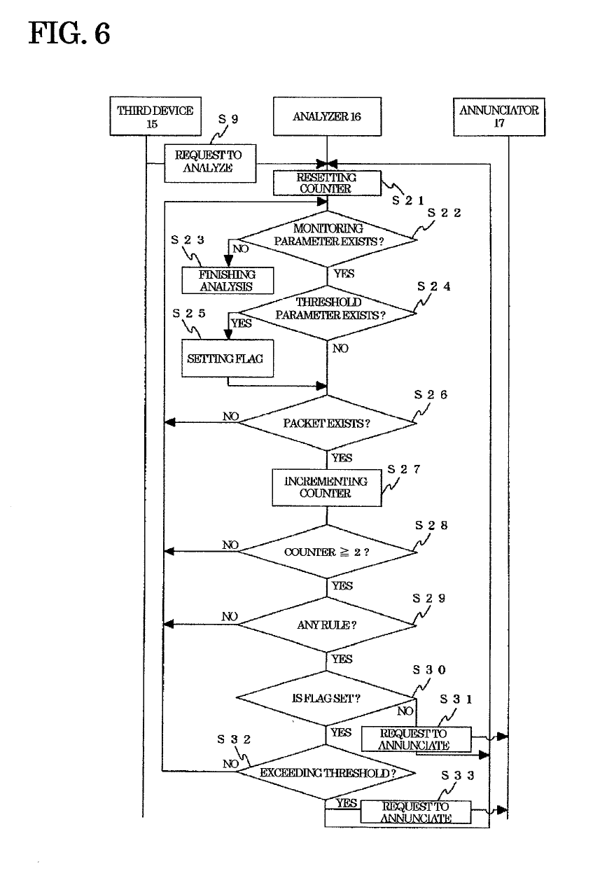

FIG. 6 is a flow-chart of an operation of the analyzer 16 in which when the analyzer 16 finds a problem in packet transmission as a result of analysis as to whether there is any rule in packet arrival times, the analyzer 16 transmits a signal to the annunciator 17.

A time at which a packet has arrived, an address of a packet transmitter, and address of a packet receiver, data sequence X, a check sum, a size of user data, and a size of header data are stored into the fourth memory 14 at a timing when a packet arrives the packet monitoring device 6 from the data communication terminal 1 or the AP server 8.

With reference to FIG. 6, the analyzer 16 receives a request from the third device 15 to start analysis as to whether there is any rule in an interval in packet arrival times, in step S9.

On receipt of the above-mentioned request, the analyzer 16 resets a counter in step S21.

Then, the analyzer 16 monitors the second memory 12 to check whether there is stored the monitoring parameter therein, in step S22.

If the monitoring parameter is not stored in the second memory 12 (NO in step S22), the analyzer 16 finishes analysis as to whether there is any rule in an interval in packet arrival times, in step S23.

If the monitoring parameter is stored in the second memory 12 (YES in step S22), the analyzer 16 monitors the third memory 13 to check whether there is stored the threshold parameter therein, in step S24.

If the threshold parameter is stored in the third memory 13 (YES in step S24), the analyzer 16 sets a flag indicating that it has been confirmed that the threshold parameter existed, in step S25.

Then, the analyzer 16 monitors the fourth memory 14 to check whether there exists a packet associated with the monitoring parameter, in step S26.

If the threshold parameter is not stored in the third memory 13 (NO in step S24), the analyzer 16 monitors the fourth memory 14 to check whether there exists a packet associated with the monitoring parameter, in step S26, without setting a flag (step S25).

If there does not exist a packet associated with the monitoring parameter (NO in step S26), steps S22 to S25 are repeated until a packet associated with the monitoring parameter is found in step S26.

If there exists a packet associated with the monitoring parameter (YES in step S26), the analyzer 16 increments a counter, in step S27.

Then, the analyzer 16 checks whether the counter indicates 2 or greater, in step S28.

If the counter indicates 1 or 0 (NO in step S28), steps S22 to S25 are repeated until the counter indicates 2 or greater.

If the counter indicates 2 or greater (YES in step S28), the analyzer 16 starts analyzing as to whether there is any rule in an interval in arrival times of the packets associated with the monitoring parameter, in step S29.

If the analyzer 16 finds no any rule (NO in step S29), steps S22 to S25 are repeated until the analyzer 16 finds a certain rule in an interval in arrival times of the packets.

If the analyzer 16 finds a certain rule in an interval in arrival times of the packets (YES in step S29), the analyzer 16 checks whether there is set the above-mentioned flag indicating that it has been confirmed that the threshold parameter existed, in step S30.

Herein, a certain rule in an interval in arrival times of the packets may be comprised of that packets arrive in every X seconds, or that packets arrive alternately in every X and Y seconds.

If the flag is not set (NO in step S30), the analyzer 16 judges that a packet which a user does not intend to transmit is transmitted through the channel 3, or that a packet which a user intentionally transmits is transmitted through the channel 3, and makes a request to the annunciator 17 to make annunciation to a user, in step S31.

Thereafter, steps 21 to 30 are carried out again.

If the flag is set (YES in step S30), the analyzer 16 checks whether the above-mentioned certain rule exceeds the threshold, in step S32.

If the rule does not exceed the threshold (NO in step S32), steps 22 to 31 are carried out again.

If the rule exceeds the threshold (YES in step S32), the analyzer 16 judges that a packet which a user does not intend to transmit is transmitted through the channel 3, or that a packet which a user intentionally transmits is transmitted through the channel 3, and makes a request to the annunciator 17 to make annunciation to a user, in step S33.

Thereafter, steps 21 to 32 are carried out again.

The control of the packet monitoring system having been mentioned so far may be accomplished as a program including various commands, and be presented through a recording medium readable by a computer.

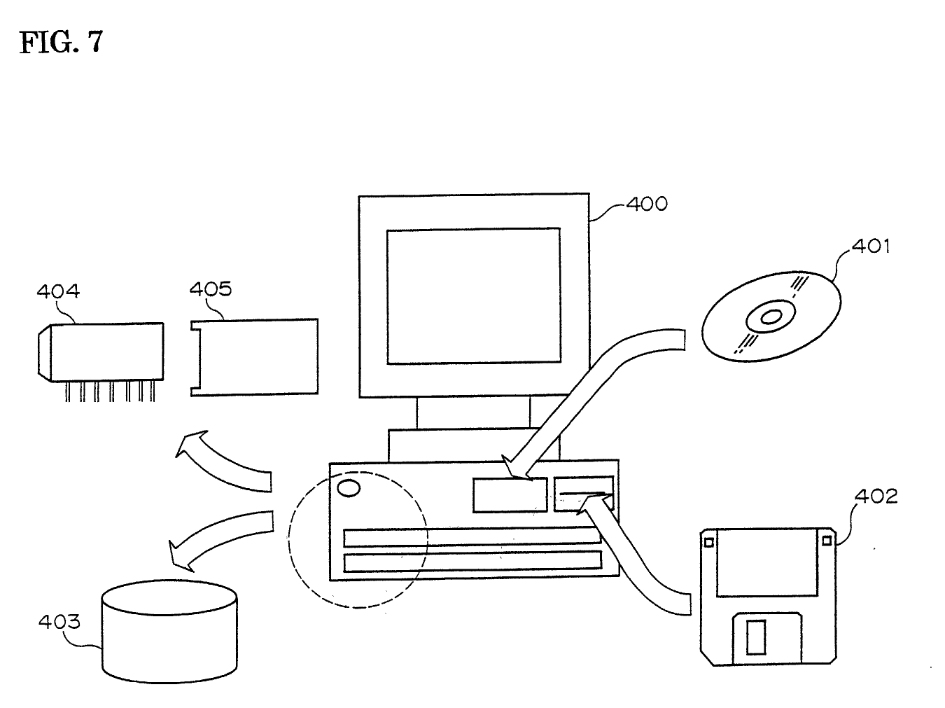

In the specification, the term “recording medium” means any medium which can record data therein. Examples of a recording medium are illustrated in FIG. 7.

The term “recording medium” includes, for instance, a disk-shaped recorder 401 such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk 402, a memory chip 404 such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM 405 such as a compact flush card, a hard disk 403, and any other suitable means for storing a program therein.

A recording medium storing a program for accomplishing the above-mentioned apparatus may be accomplished by programming functions of the above-mentioned apparatuses with a programming language readable by a computer, and recording the program in a recording medium such as mentioned above.

A hard disc equipped in a server may be employed as a recording medium. It is also possible to accomplish the recording medium in accordance with the present invention by storing the above-mentioned computer program in such a recording medium as mentioned above, and reading the computer program by other computers through a network.

As a computer 400, there may be used a personal computer, a desk-top type computer, a note-book type computer, a mobile computer, a lap-top type computer, a pocket computer, a server computer, a client computer, a workstation, a host computer, a commercially available computer, and electronic exchanger, for instance.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-050476 filed on Feb. 22, 2000 including specification, claims, drawings and summary is incorporated herein by reference in its entirety.

What is claimed is:

1. A system for monitoring packets transmitted on a channel connecting an application server and a user of said application server to each other, comprising:
(a) a certification server which certificates a user; and
(b) a first device which, on receipt of a request from said certification server, monitors packets transmitted on said channel.

2. The system as set forth in claim 1, wherein said certification server includes:
(a1) a first memory which stores a user management table including ID numbers of users, passwords by which users are identified, a monitoring parameter designating a packet to be monitored, and a threshold parameter designating a method of monitoring said packet; and
(a2) a second device which transmits a request to said first device to start or finish monitoring said packet at a timing when said user logs-in or logs-out his/her terminal.

3. The system as set forth in claim 2, wherein said first device includes:
(b1) a second memory which stores a first time at which a packet transmitted from one of said application server and said user arrives, when said first device receives a request from said second device to monitor said packet;
(b2) an analyzer which monitors a second time at which packets coincident with said monitoring parameter arrive, based on said first time, when said first device receives a request from said second device to monitor said packet, and determines whether there is any rule in an interval in said second time; and
(b3) an annunciator which makes annunciation to said user when there is a certain rule in said interval.

4. The system as set forth in claim 2, wherein said certification server includes a third device which updates said monitoring parameter and said threshold parameter, when instructed by said user.

5. The system as set forth in claim 2, wherein said first device include:
(b1) a third memory which stores said monitoring parameter transmitted from said second device;
(b2) a fourth memory which stores said threshold parameter transmitted from said second device; and
(b3) a fourth device which said third and fourth memories when said second device transmits a request to said first device to start or finish monitoring said packet.

6. The system as set forth in claim 3, wherein said first device include:
(b1) a third memory which stores said monitoring parameter transmitted from said second device;
(b2) a fourth memory which stores said threshold parameter transmitted from said second device; and
(b3) a fourth device which said third and fourth memories when said second device transmits a request to said first device to start or finish monitoring said packet.

7. The system as set forth in claim 6, wherein said analyzer analyzes whether there is any rule in said interval and whether said interval exceeds said threshold parameter, and said annunciator makes annunciation to said user when said analyzer judges that there is a certain rule in said interval and that said interval exceeds said threshold parameter.

8. A method of monitoring packets transmitted on a channel connecting an application server and a user of said application server to each other, comprising the steps of:
(a) acquiring a monitoring parameter indicative of a packet to be monitored, when said user logs-in his/her terminal;
(b) monitoring a time at which packets coincident with said monitoring parameter arrive, and determining whether there is any rule in an interval in said arrival time; and
(c) making annunciation to said user when there is a certain rule in said interval.

9. The method as set forth in claim 8, further comprising the step of ceasing said step (b) when said user logs-out his/her terminal.

10. The method as set forth in claim 8, wherein said monitoring parameter is included in a user management table which further includes an ID number of said user, a password by which said user is identified, and a threshold parameter designating a method of monitoring said packet, and said step (a) includes the steps of:
(a1) retrieving said user management table, based on said ID number and said password both input by said user;
(a2) acquiring said monitoring parameter, if said monitoring parameter is stored in said user management table; and
(a3) acquiring said threshold parameter, if said threshold parameter is stored in said user management table.

11. The method as set forth in claim 10, wherein said step (b) includes the step of analyzing whether there is a certain rule in said interval and whether said interval exceeds said threshold parameter, after acquiring said threshold parameter in said step (a2), and said step (c) includes the step of making annunciation to said user, if there is a certain rule in said interval and said interval exceeds said threshold parameter.

12. A recording medium readable by a computer, storing a program therein for causing a computer to act as a system for monitoring packets transmitted on a channel connecting an application server and a user of said application server to each other, said system comprising:
(a) a certification server which certificates a user; and
(b) a first device which, on receipt of a request from said certification server, monitors packets transmitted on said channel.

13. The recording medium as set forth in claim 12, wherein said certification server includes:
(a1) a first memory which stores a user management table including ID numbers of users, passwords by which users are identified, a monitoring parameter designating a packet to be monitored, and a threshold parameter designating a method of monitoring said packet; and
(a2) a second device which transmits a request to said first device to start or finish monitoring said packet at a timing when said user logs-in or logs-out his/her terminal.

14. The recording medium as set forth in claim 13, wherein said first device includes:
(b1) a second memory which stores a first time at which a packet transmitted from one of said application server and said user arrives, when said first device receives a request from said second device to monitor said packet;
(b2) an analyzer which monitors a second time at which packets coincident with said monitoring parameter arrive, based on said first time, when said first device receives a request from said second device to monitor said packet, and determines whether there is any rule in an interval in said second time; and
(b3) an annunciator which makes annunciation to said user when there is a certain rule in said interval.

15. The recording medium as set forth in claim 13, wherein said certification server includes a third device which updates said monitoring parameter and said threshold parameter, when instructed by said user.

16. The recording medium as set forth in claim 13, wherein said first device include:
(b1) a third memory which stores said monitoring parameter transmitted from said second device;
(b2) a fourth memory which stores said threshold parameter transmitted from said second device; and
(b3) a fourth device which said third and fourth memories when said second device transmits a request to said first device to start or finish monitoring said packet.

17. The recording medium as set forth in claim 14, wherein said first device include:
(b1) a third memory which stores said monitoring parameter transmitted from said second device;
(b2) a fourth memory which stores said threshold parameter transmitted from said second device; and
(b3) a fourth device which said third and fourth memories when said second device transmits a request to said first device to start or finish monitoring said packet.

18. The recording medium as set forth in claim 17, wherein said analyzer analyzes whether there is any rule in said interval and whether said interval exceeds said threshold parameter, and said annunciator makes annunciation to said user when said analyzer judges that there is a certain rule in said interval and that said interval exceeds said threshold parameter.

19. A recording medium readable by a computer, storing a program therein for causing a computer to carry out a method of monitoring packets transmitted on a channel connecting an application server and a user of said application server to each other, said method comprising the steps of:
(a) acquiring a monitoring parameter indicative of a packet to be monitored, when said user logs-in his/her terminal;
(b) monitoring a time at which packets coincident with said monitoring parameter arrive, and determining whether there is any rule in an interval in said arrival time; and
(c) making annunciation to said user when there is a certain rule in said interval.

20. The recording medium as set forth in claim 19, wherein said method further includes the step of ceasing said step (b) when said user logs-out his/her terminal.

21. The recording medium as set forth in claim 19, wherein said monitoring parameter is included in a user management table which further includes an ID number of said user, a password by which said user is identified, and a threshold parameter designating a method of monitoring said packet, and said step (a) includes the steps of:
(a1) retrieving said user management table, based on said ID number and said password both input by said user;
(a2) acquiring said monitoring parameter, if said monitoring parameter is stored in said user management table; and
(a3) acquiring said threshold parameter, if said threshold parameter is stored in said user management table.

22. The recording medium as set forth in claim 21, wherein said step (b) includes the step of analyzing whether there is a certain rule in said interval and whether said interval exceeds said threshold parameter, after acquiring said threshold parameter in said step (a2), and said step (c) includes the step of making annunciation to said user, if there is a certain rule in said interval and said interval exceeds said threshold parameter.
